(19) United States
(12) Patent Application Publication
(10) Pub. No.: US 2014/0160337 A1
(43) Pub. Date: Jun. 12, 2014

(54) CAMERA VIEWFINDER COMPRISING A PROJECTOR

(71) Applicant: GVBB Holdings, S.A.R.L, Luxembourg (LU)

(72) Inventor: Ben VAN DEN HERIK, Oosterhout (NL)

(73) Assignee: GVBB Holdings, S.A.R.L, Luxembourg (LU)

(21) Appl. No.: 13/950,041

(22) Filed: Jul. 24, 2013

Related U.S. Application Data
(60) Provisional application No. 61/675,273, filed on Jul. 24, 2012.

(51) Int. Cl. H04N 5/232; H04N 9/31

(52) U.S. Cl. CPC H04N 5/23293; H04N 9/3179
USPC 348/333.1

(57) ABSTRACT

A viewfinder is described that is constructed using a projection system contained within the viewfinder housing. The projection system enables the viewfinder to offer a selectable display resolution and configurable aspect ratio. The viewfinder comprises a light source, one or more imaging panels and a screen that displays the image. The viewfinder has a housing that is adapted for mounting on a camera, and the camera provides a video feed from which the image is derived. The screen may be a rear-projection screen or a front projection screen. The imaging panels may comprise liquid crystal display panels or a digital micromirror device.

### CROSS-REFERENCE TO RELATED APPLICATION

This application claims the benefit of and right of priority to U.S. Provisional Application Serial No. 61/675,273, filed on Jul. 24, 2012, which is expressly incorporated by reference herein in its entirety.

### BACKGROUND

1. Field

The present disclosure relates generally to video camera systems, and more particularly, to viewfinders used in camera systems.

2. Background

Camera viewfinders enable a camera operator to control certain aspects of images captured by cameras including, for example, image content, focus, etc. In video cameras, the viewfinder displays video captured by the camera in a small display screen that may have a diagonal measurement of between 2 inches and 9 inches. Cathode ray tube (CRT) technology has been long used for viewfinders in studio-quality camera systems but CRT systems may not be readily adaptable to high definition applications. These conventional systems often employ monochrome CRT displays for use in viewfinders.

Most conventional broadcast cameras do not have an auto focus system and an operator must use a viewfinder with sufficient resolution to be able to manually focus a picture captured by the camera. High resolution cameras typically use a viewfinder that has a high resolution monochrome CRT display with a dimension of about 2 inches. However, availability of such CRT displays is limited and many replacement display technologies suffer from lower resolution and/or poor dynamic response.

### SUMMARY

In an aspect of the disclosure, a viewfinder may be constructed using a projection system contained within the viewfinder housing. The projection system enables the viewfinder to offer a selectable display resolution and configurable aspect ratio.

In an aspect of the disclosure, a viewfinder comprises a light source, one or more imaging panels that produce an optical output representative of an image using light received from the light source, a screen that displays the image. A housing encloses the light source, the one or more imaging panels and the screen. The housing may be adapted to receive an eyepiece used to view the image displayed on the screen. The eyepiece may be used to magnify the image.

In an aspect of the invention, the optical output of the imaging panels may be produced from a video signal provided by the camera. The screen may be rectangular and typically has a diagonal dimension that is nine inches or less. In some embodiments, the screen has a diagonal dimension of two inches or less.

In an aspect of the disclosure, the screen has a resolution sufficient to display standard definition images and/or high definition images. In one example, the screen has a resolution that is selectable between 800×480 pixels and 1280×800 pixels. Images may have various resolutions and be in various formats. An example format is Wide Extended Graphics Array (WXGA). An example resolution is 1280×800 pixels. However, one of ordinary skill in the art will appreciate that different resolutions and/or different formats may be implemented without deviating from the scope of the claims.

In an aspect of the disclosure, the screen has a front side and a rear side, and the screen receives the optical output on the rear side of the screen, while the image is viewable on the front side of the screen through the eyepiece. The screen may be constructed from a particulate material such that the screen is characterized by a granularity at its surface and/or within its interior. The resolution of the screen may be determined by the granularity. The screen may be constructed from a fibrous material, and the resolution of the screen is determined by fiber width. The screen may comprise a polytetrafluoroethylene (PTFE) foil.

In an aspect of the disclosure, the image is viewable as a reflection from the screen and the resolution of the screen is determined by a texture of a surface of the screen. The texture of the surface of the screen may be derived from one or more of a chemical treatment of the surface, an embossing of the surface, and an etching of the surface.

In an aspect of the disclosure, the light source produces white light, and a plurality of color filters provides a different colored light to each of the one or more imaging panels. In some embodiments, the light source sequentially produces light having different wavelengths, and the one or more imaging panels comprises a single panel that is sequentially illuminated with the different light.

In an aspect of the disclosure, the one or more imaging panels comprise a digital micromirror device (DMD). In an aspect of the disclosure, the one or more imaging panels comprise a liquid crystal display panel.

In an aspect of the disclosure, one or more optical elements are configured to provide a desired optical path length between the imaging panel and the screen. The optical elements may include reflective and/or refractive elements.

### BRIEF DESCRIPTION OF THE DRAWINGS

FIG. 1 is a block diagram illustrating an example of a camera equipped with a viewfinder according to certain aspects of the invention.

FIG. 2 is a block diagram illustrating front and rear projection viewfinders.

FIG. 3 is a diagram illustrating certain aspects of screen materials.

FIG. 4 depicts certain configurations of certain aspects of the invention.

FIG. 5 is a conceptual block diagram illustrating the operation of imaging devices.

FIG. 6 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Certain aspects of video production systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, image processors, digital signal processors (DSPs), field programmable gate arrays (FPGAs), programmable logic devices (PLDs), state machines, gated logic, discrete hardware circuits, and other suitable hardware configured to perform the various functionalities described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, non-transitory storage such as a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, as well as a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Certain embodiments of the described invention provide an adaptable viewfinder that may be used to display video images having a broad range of formats and/or resolutions. A projection system may be provided within the viewfinder. The projection system may comprise a screen having a diagonal size that can be less than 2 inches. The projection system may be used as a replacement and/or upgrade for cathode ray tube (CRT) viewfinder displays. The projection system may provide various resolutions, and may support both black and white, and color displays.

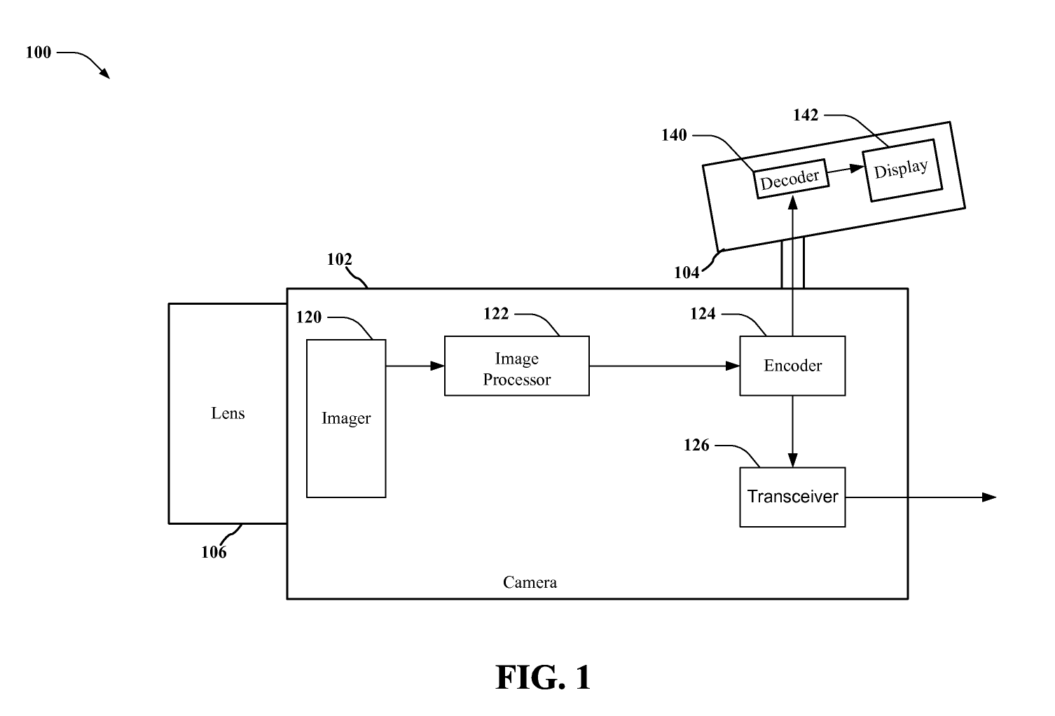

FIG. 1 is a simplified block diagram illustrating a camera system 100. Camera system 100 may comprise a camera 102, a viewfinder 104, and a lens system 106. Camera 102 may include an imaging device 120, which may comprise one or more CCD imaging devices. Camera 102 may comprise one or more image processors 122 that receive a sequence of images and produce a video output having a desired frame rate, aspect ratio, etc. An encoder 124 may receive a raw video output from image processor 122 and produce a compressed output that may be transmitted to a video production system and/or over a network using transceiver 126. Encoder 124 may also provide a video feed to viewfinder 104. Video feed may be a raw video feed, but the video feed may comprise an encoded and/or compressed signal in some embodiments.

Viewfinder 104 may include a decoder 140 that receives video from camera 102 and provides image data for display using display system 142. In one example, decoder 140 and display system 142 communicate through shared memory. In another example, display system 142 may receive a formatted and/or encoded video stream. The viewfinder 104 may provide images in color. An example of such a color viewfinder is a 2.7″ quarter high definition (QHD) liquid crystal display (LCD) color panel.

A video processing system of the viewfinder 104 may include a scalar. The scalar may convert incoming video signals into a particular format and/or resolution. The video signal may be received from the camera 102. The video signal may be converted to a resolution corresponding to a compact pico projector engine. For example, the scalar may convert video signals to a Wide Extended Graphics Array (WXGA) format with a resolution of 1280×800 pixels. The scalar may also convert the video signals to other format types and/or resolutions. One of ordinary skill in the art will appreciate that different resolutions and/or different formats may be implemented without deviating from the scope of the claims.

Lens system 106 may be controlled to provide a desired optical configuration of lenses, which configuration may specify, for example, a depth of field setting, a numerical aperture, and a focal length.

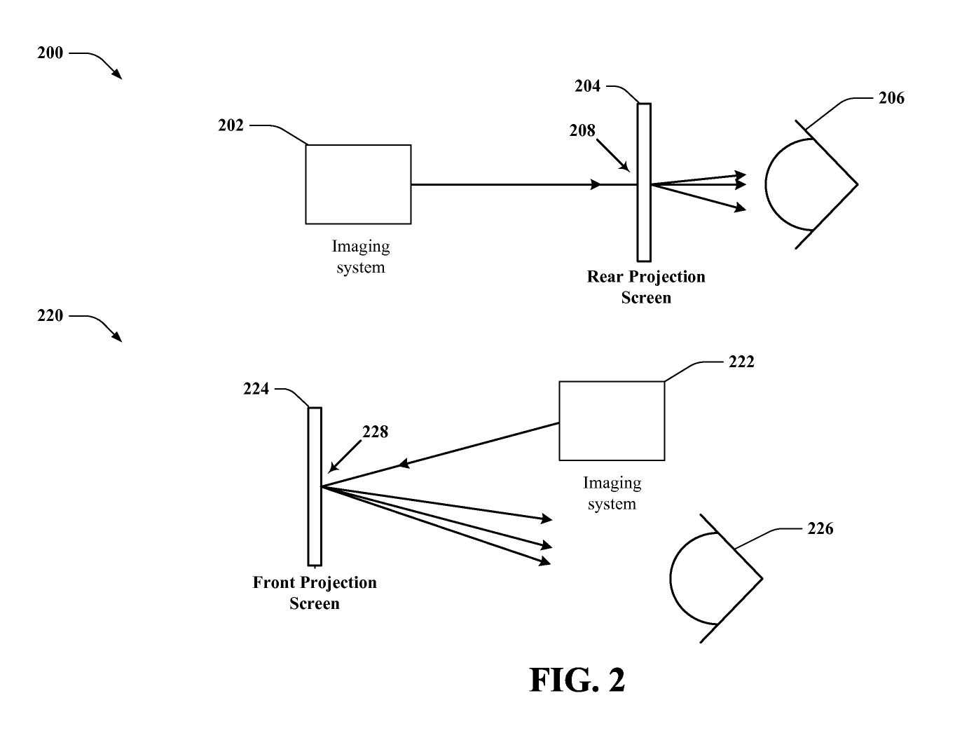

FIG. 2 depicts a simplified block diagram illustrating different modes of projection 200 and 220 in a video projection system embodied within viewfinder 104. An imaging system 202 or 222 generates an image for projection on screen 204 or 224, respectively. The screens 202 and 222 may be positioned at a focal plane of the imaging system 202 and 222 and the image may be made visible to an observer 206 or 226 because of diffuse light scattering that occurs as light enters, traverses, and/or exits the body 208 of screen 204 or because of reflective scattering 228 that occurs at the surface of screen 224.

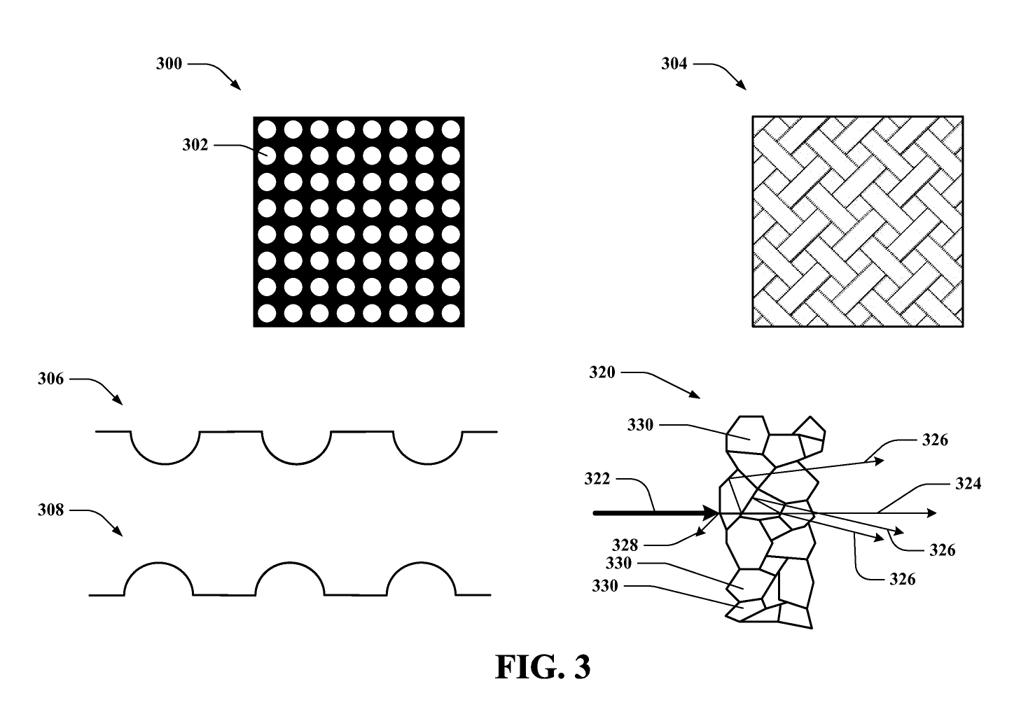

In rear-projection mode 200, an image is projected toward one side of screen 204 and viewed by an observer 206 from the other side of screen 204. In some embodiments, the observer 206 views the image through an eyepiece, which may magnify or otherwise adjust or correct the viewed image. Rear-projection screen 204 is typically constructed from a translucent material that passes light with some amount of scattering caused by diffuse reflection within the translucent material, or at one or more surfaces of the screen 204. A transmission factor and the amount of scattering may be determined by the size of particulates (i.e. granularity) in the translucent material, strand sizes of fibers in the translucent material and/or a weave 304 or other patterns 300 within or upon the surfaces of the translucent material (see FIG. 3).

The projection screen material is typically configured to scatter light such that an image focused on the projection screen 204 or 224 may be viewed from different angles. Pattern 300 illustrates an idealized pattern of particles that may be used for a back-projection screen 204. The lighter spots 310 represent areas of translucency that are approximately the size of one pixel in an image and that act as a point source of light representative of the pixel. Pattern 300 may also represent an idealized front-projection screen 224, where the lighter spots 310 represent highly reflective areas.

In some embodiments, texture on the surface of projection screen material may be created using a fibrous material that may have a generally woven structure 304. In some embodiments, a textured surface of projection screen material may be derived from particles from which the projection screen material is constructed and/or which may be embedded in the surface of projection screen material. In some embodiments, surface of projection screen material may be textured by chemical treatment, or by embossing and/or by etching. In one example, a white colored PTFE foil used for projection screen has a thickness of approximately 100 μm. PTFE foil may comprise a textured surface and be manufactured with suitable properties to act as a rear projection screen. These properties may include porosity, pore size, density and other characteristics.

In some embodiments, near-ideal diffuse reflection of light, characterized by omnidirectional scattering of light, may be accomplished by controlling the grain size, weave, particle size and other attributes of the screen material. The translucent material may be selected based on a plurality of additional properties that may include the transmission factor of the screen, which can affect brightness. The use of translucent materials with high diffusion properties may result in lower transmission factors and may necessitate the use of higher-powered light sources.

In front-projection mode 220, an image may be projected on the same side 228 of the screen 224 that is viewed by a camera operator or other observer 226. Front projection systems may use a screen 224 that is constructed from high reflectivity materials. Screen 224 may have a surface texture that is selected and controlled to provide a desired resolution. For example, the surface 228 of screen 224 may comprise a roughened or pitted surface that has peaks, valleys, pits and other discontinuities 306, 308 that serve to diffusively reflect incident light. The size and frequency of occurrence of the discontinuities may determine the resolution of screen 224 and, as a consequence, of the viewfinder.

A cross-section view of a screen 320 is also shown for illustrative purposes in FIG. 3. Depending on the physical properties of the material, the screen 320 may be usable in rear-projection or front-projection modes. For example, if the surface of the material is highly reflective, the screen 320 may be used in front-projection systems. If the material has a high transmission factor, then the material may be usable for a rear projection system. As illustrated, some light 328 is reflected backwards, some light 324 passes through the material and other light 326 is scattered. Some light may also be absorbed. Scattering may occur at the boundaries of particles 330 and/or fibrous materials in the screen material. The size of the particles 330 may affect resolution of the screen because each point at which light can be reflected or scattered may delineate a pixel or pixel boundary.

Projection screen 204 or 224 may be constructed using a material that has a textured surface, a porosity and/or a structure comprising fine particles, where the texture of the surface, pores and/or fine define a dimension that may be less than the dimension of a single pixel in the displayed image. In some embodiments, the texture of the surface, pores and/or fine define a dimension that may be close in magnitude to the dimension of a single pixel in the displayed image.

Imaging system 202 or 222 may receive images for projection from one or more of an image processor 122, encoder 124 and an outside video feed. Images may be produced by a camera 102, a video production system, a video recorder, and so on. The image projected on the screen may be viewed along a direct line of sight or along an optical path that includes one or more of a lens system, a mirror and a prism. The displayed image may have one of a plurality of aspect ratios, and may be provided in either black and white or color.

Rear-projection screen 204 may be constructed using a material selected for its diffusion properties. Diffusive materials permit light to pass through the material with limited absorption, but with significant scattering. Scattering may result from repeated scattering events which change the direction of the path of photons (see FIG. 3). Diffusion is related to the extent of light scattering in the material. A viewer of the screen typically observes the scattered light. The granularity and/or surface roughness of a diffusive material can determine the resolution obtainable using the material for a display screen 204, 224. For a rear-projection screen 204, thickness of the screen may also be determinative of its diffusive properties. In some embodiments a PTFE foil with thickness of 0.1 mm is used in rear-projection screen 204 to obtain high resolution and high contrast.

Projection systems may exhibit uneven light distribution resulting in an effect that may be referred to as a hot spot. Hot spots may occur when a reflection or other diffused image of a light source or lens, particularly for front-projection systems. Hot spots may occur in rear projection systems because light dispersion from the projection screen 308 may be dependent on the angle of light rays from the projection optics 306, and because the limited light path length of the compact projection system 302 may create a considerable range of angles of light rays.

A hotspot may be observable in a rear projection display screen 204. Hot spots occur when the screen material is thin or lightly diffusive. The hotspot is a diffused image of the light source. Hotspots may be suppressed by eliminating a straight line of sight through the screen 204 to the light source (relative to the optical path). In one example, the screen 204 may be deployed at an angle to the light path. Image generation processors and software may be adapted to remove the keystone distortion that would otherwise arise from the angled display screen 204. Hotspots may be avoided by tilting the angle of viewing, by orientation of an eyepiece, for example. Hotspots may be avoided by coating one or more surfaces of lenses, mirrors and prisms. Keystone correction resulting from tilting the projection screen 204 may be performed either optically, or by processing the video signal provided to the image panel 204.

In certain embodiments, the screen material for a rear-projection screen 204 may be selected or configured to achieve a reflection coefficient that reduces or eliminates glare arising from reflected stray light or invading light that may leak through a housing of the viewfinder 104 and/or a projection display system. In some embodiments, a light absorbing layer may be applied to the screen to prevent ambient light from reflecting from the viewed, front side of the screen. In some embodiments, the housing can be sealed to prevent stray light from entering the viewfinder.

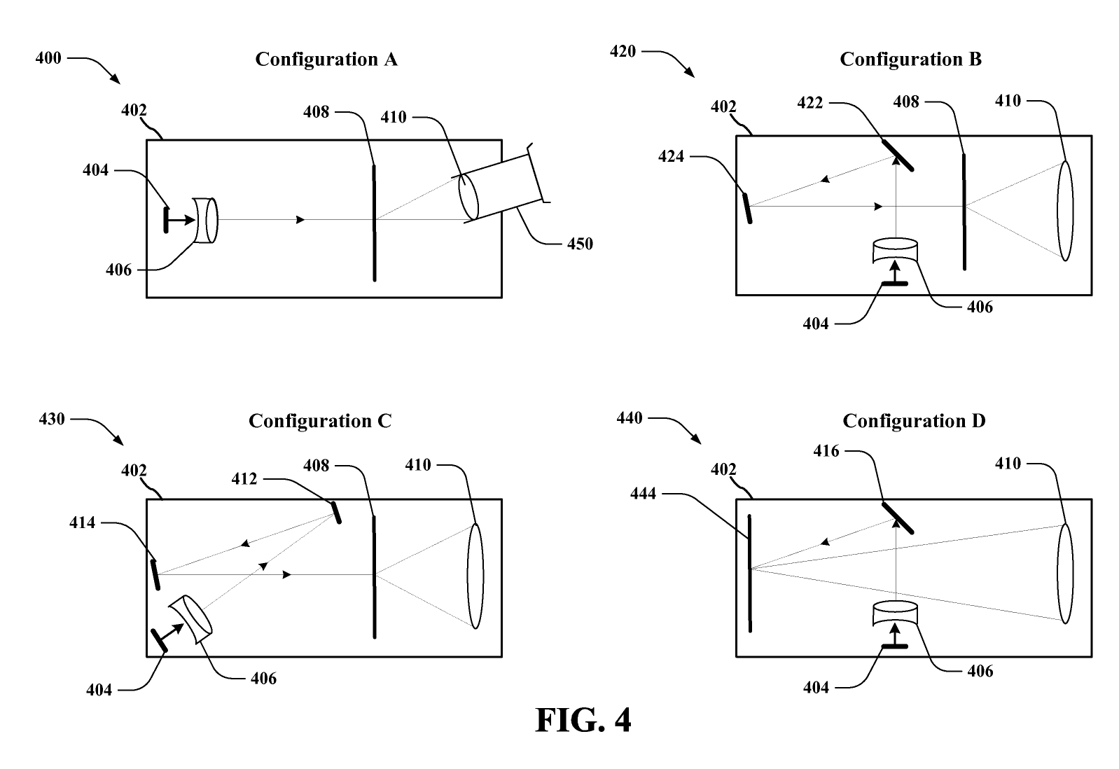

FIG. 4 includes simplified block schematics 400, 420, 430, and 440 that illustrate operational configurations of components within a viewfinder projection system 402. The simplified block schematics 400, 420, 430, and 440 (Configurations A, B, C, and D, respectively) illustrate different examples of viewfinder projector systems that may be configured to be a monocular viewfinder. For each configuration, viewfinder 104 (see FIG. 1) may comprise a projection system 402 that includes an imaging panel 404, an objective lens system, which may comprise a projection lens 406 and a projection screen 408 or 444. Projection screen 408 may be adapted for rear-projection applications, while projection screen 444 may be used for front-projection implementations. In some embodiments, objective lens system may comprises a simple lens system 410 configured to magnify and/or focus images displayed on projection screen 408 or 444. Projection system 402 may be located in the same space that would be occupied by a CRT or other viewfinder display system replaced by projection system 402. In some embodiments, magnifier optics 410 may have been developed for a CRT-based viewfinder display system. Projection system 402 may have different internal configurations 400, 420, 430 and 440. A configuration 400, 420, 430 or 440 is typically selected to obtain desired optical path characteristics for rear-projection and front-projection modes. Optical path characteristics may relate to the length and/or geometry of the light path between imaging panel 404 and projection screen 408 or 444. Optical path characteristics may be determined based on the imaging source used in the viewfinder projection system 402. Imaging panel 404 may comprise different colored panels (e.g., red, blue and green panels) or a single panel that is sequentially illuminated with three different light wavelengths to approximate a full spectrum of visible light. Moreover, imaging panel 404 may be light reflective or light conductive. Accordingly, configurations 400, 420, 430 or 440 depict a single light path for simplicity of explanation and may be adapted to accommodate the type of light source and imaging panels 404 used.

Projection system 402 typically comprises a compact optical engine that includes imaging panel 404, projection lens 406 that produces an image for projection on screen 408 or 444. Additional optical elements 422, 424, 432, 434, and 442, including one or more refractive and/or reflective elements, may be configured to provide a pre-focused and aligned optical output such that the optical engine can be quickly installed within viewfinder 204 with relatively minor adjustment to obtain a focused image on projection screen 408 or 444. In some embodiments, a compact optical engine may also comprise projection screen 408 or 444. In some embodiments, an optical engine may be configurable for use with projection screens 408, 444 of various dimensions. For example, projection screen 408 or 444 may have a diagonal dimension of approximately 2 inches. Projection screen 408 or 444 may have larger diagonal dimensions of 7 inches, 9 inches, etc., or a smaller diagonal dimension, as desired or as determined by the specification and requirements of viewfinder 104.

In one configuration 400, a projection system 402 has a relatively simple light path between projection optics 406 and back-projection screen 408. Projection optics 406 typically comprise a plurality of lenses that receives light from imaging panel 404 and that provides a focused image in a plane coincident with back-projection screen 408, and with a desired depth of focus that can maintain a focused image under normal operating conditions. For example, variations in temperature may cause expansion or contraction of certain viewfinder components 204, thereby causing increased or reduced light paths.

Configurations 420 and 430 illustrate projection systems 402 that employ reflective elements 422, 424, 432 and 434 to increase the path length between imaging panel 404 and projection screen 408. One or more of reflective elements 422, 424, 432 and 434 may comprise convex or concave mirrors, prisms and so on. Additional optical elements may be deployed along the light path between imaging panel 404 and projection screen 408 to focus, defocus, combine and/or deflect light.

Configuration 440 illustrates a projection system 402 that includes one or more reflective elements 442 for directing light from imaging panel 404 onto front-projection screen 444. Projection screen 444 may exhibit lower attenuation than rear project screens 444 and may simplify construction of projection system. The reflective elements 442 may comprise any combination of convex or concave mirrors, prisms, etc.

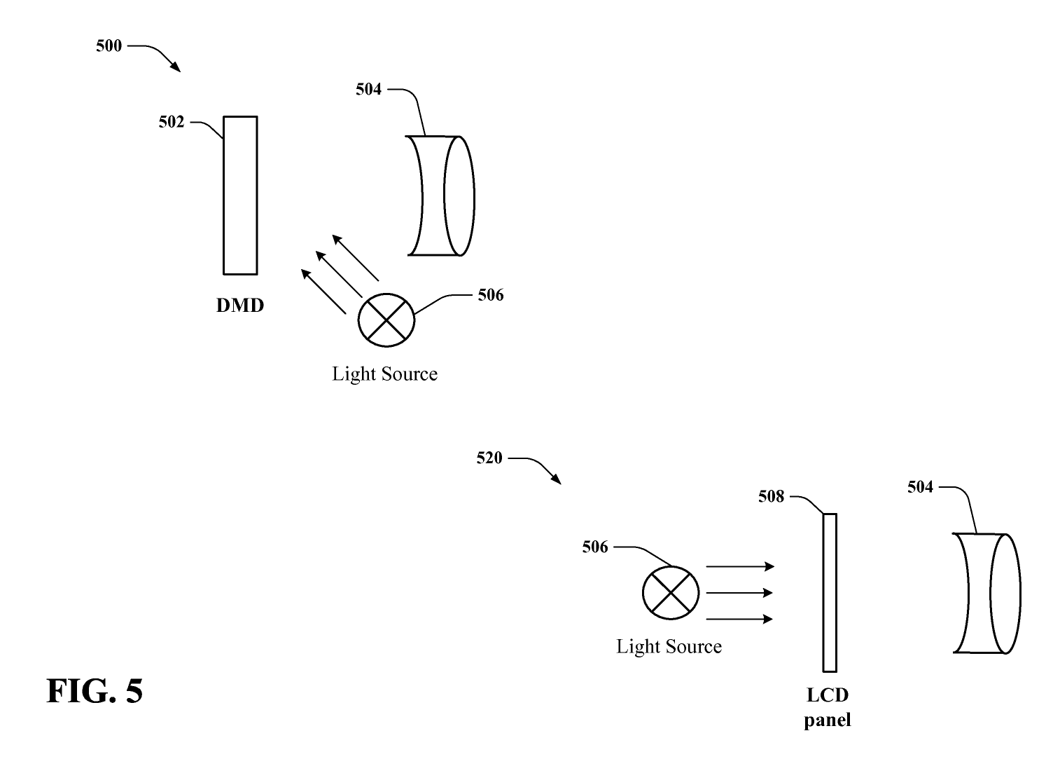

FIG. 5 includes illustrates examples 500 and 520 of imaging panel 404 implementations. An imaging panel 404 (see FIG. 4) may be selected to obtain a performance characterized by one or more of a desired resolution, a specified luminous intensity or luminance, a screen size, energy consumption and heat generation and dissipation. In one example, the projection system 402 may be required to produce a display having a resolution that is selectable between 800×480 pixels, and 960×540, while consuming less than 3 Watts power. Images may have various resolutions and be in various formats. An example format is Wide Extended Graphics Array (WXGA). An example resolution is 1280×800 pixels. However, one of ordinary skill in the art will appreciate that different resolutions and/or different formats may be implemented without deviating from the scope of the claims. In some embodiments, the projection system may have a form factor that is in conformance with standards-based specifications for camera and other viewfinders. The projection system may be required to produce an image having a minimum luminance, such as a luminance of at least 300 candela per square metre (cd/m²), and a contrast ratio that is greater than 400 or more, in order to meet or exceed the contrast of an equivalent twisted nematic liquid crystal display (LCD) panel.

In the embodiment illustrated at 500, a digital light processor (DLP™) 502 is used to generate a projection image. A DLP™ device can create an image using a matrix of microscopically-small mirrors fabricated on a semiconductor integrated circuit (IC), and the DLP™ device may be referred to as DMD 502. The micromirrors are typically actuated using electrostatic forces to switch the mirror between an on (reflecting) and off (nonreflecting) position. Each mirror of DMD 502 represents a pixel in the projected image. In the on state, light incident onto the mirror is reflected into the lens making the pixel appear bright on the screen. In the off state, the light is directed away from the lens and is internally absorbed, thereby causing the pixel to appear dark. Although, the DMD 502 operates primarily as a digital device, individual mirrors can be pulsed to provide a grayscale effect between on and off positions. In one example, a DMD 502 having a maximum switching frequency of approximately 66 KHz may support 256 gray levels.

A light source 506 provides the light selectively reflected by the micromirrors of DMD 502. To project a color image, three DMDs 502 may be used to generate red, blue and green components of the complete image using color filters to provide colored light to each of the three DMDs 502. Alternatively, a single DMD 502 may receive a multiplexed image, with a sequence of image portions being used to selectively reflect a current color of light provided by light source 506. Optical element 504 may be deployed along the light path, and may include elements for combining three or more colored image portions.

In the embodiment illustrated at 520, an image for projection is generated using one or more LCD panels 508. Light source 506 directs a light through LCD panel 508, which forms a mask representative of the image to be displayed. Three LCD panels 508 may be used to generate red, blue and green components of the complete color image using color filters to provide colored light to each of the three LCD panels 508. Alternatively, a single LCD panel 508 may receive multiplexed portions of the color image, each portion being used to selectively pass a color portion of the complete image. Light source 506 may comprise filters to produce the colored light. Optical element 504 may be deployed along the light path, and may include elements for combining three or more colored image portions.

To obtain a color display, multiple panels 502 or 508 may be used, each providing a different color of the final image. Typically, three colors are combined to obtain a color image, the colors comprising red, green and blue. One or more dichroic filters or mirrors may be used to combine the images. A dichroic filter may comprise a thin-film filter, or interference filter which exhibits very accurate color filtering and selectively passes light of a small range of wavelengths (i.e. colors) while reflecting the other colors. A dichroic mirror or reflector may reflect a small range of wavelengths. In some embodiments, LEDs are used as a light source 506. LED color dichroics may be used to merge the separate color light derived from LED light sources into a single beam. LED color dichroics are specifically optimized for random polarized light emitted from LEDs, providing high transmission and reflection in the respective wavelength ranges of the LED colors. The three-colored light may then be homogenized using fly's eye homogenizers or other homogenizing optics. Homogenizers are used to spread light in order to obtain an evenly illuminated surface at the DMD 502 or LCD panel 508.

Some embodiments use a single DMD 502 or LCD panel 508, illuminated with different wavelength light in a repeating sequence to obtain an image. This field-sequential-color (FSC) approach involves the display in quick successions of three sub-pictures or fields, which are typically the red, blue and green primary colors.

Other technologies can be used to generate images. In one example, an image generation is accomplished using a liquid crystal on silicon (LCoS) panel. In another example, an organic light-emitting diode (OLED) may be used, whereby a light-emitting diode (LED) is coated with an emissive electroluminescent layer formed from an organic compound which emits light in response to an electric current. These and other devices may be used to generate projection images.

Certain embodiments of the invention provide a viewfinder comprising a low cost display system, with high brightness and a much wider color spectrum than can be obtained with direct view LCD panels.

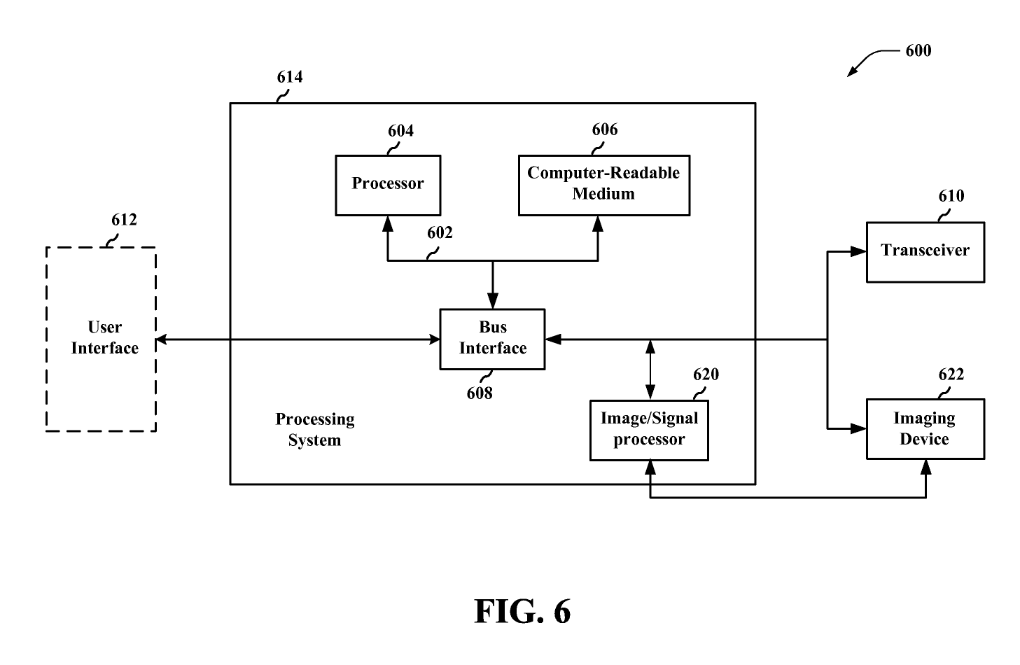

FIG. 6 is a conceptual diagram illustrating an example of a hardware implementation for an apparatus 600 employing a processing system 664. In this example, the processing system 664 may be implemented with a bus architecture, represented generally by the bus 602. The bus 602 may include any number of interconnecting buses and bridges depending on the specific application of the processing system 664 and the overall design constraints. The bus 602 links together various circuits including one or more processors 604, represented generally by the processor 604 and image processor 620, signal processor 620 or other specialized processor 620, and non-transitory computer-readable media, represented generally by the computer-readable medium 606. The bus 602 may also link various other circuits such as timing sources, peripherals, voltage regulators, and power management circuits, which are well known in the art, and therefore, will not be described any further. In some embodiments, a bus interface 608 provides an interface between the bus 602 and a transceiver 660. The transceiver 660 provides a means for communicating with various other apparatus over a transmission medium. In some embodiments, bus interface 608 may provide an interface between the bus 602 and an imaging device 622. The imaging device 622 may capture a sequence of images of a scene or event to enable processing system 664 to produce a video feed. Image processor 620 may be configured to operate on pixels in the sequence of images to produce a signal representative of one or more images captured by the imaging device 622. In one example, processing system 664 may be incorporated in a camera, such that imaging device 622 comprises a CCD array or another device suitable for capturing images that provides a “raw” image signal directly to image/signal processor 620, which may process pixel information in a sequence of images to produce a standardized video output representative of a sequence of frames. In another example, imaging device 622 may comprise a camera in which image processor 620 may be employed to extract information from a signal representative of sequence of frames transmitted by imaging device 622. The extracted information may comprise a compressed video stream and metadata including background information, foreground objects, motion vectors, virtual lines, object counting, object tracking and other metadata. Depending upon the nature of the apparatus, a user interface 662 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 664 to perform the various functions described infra for any particular apparatus. The computer-readable medium 606 may also be used for storing data that is manipulated by the processor 604 when executing software.

By way of example and without limitation, the aspects of the present disclosure illustrated in FIG. 6 are presented with reference to systems and methods used to configure various components of a video production system that may be used for production of television programming or at sports events. The various concepts presented throughout this disclosure may be implemented across a broad variety of imaging applications, including systems that capture and process video and/or still images, video conferencing systems and so on. Accordingly, certain embodiments provide a viewfinder 104 for a camera 102. The viewfinder 104 may comprise a housing 402 and an eyepiece 450 that may magnify, focus or otherwise correct or adjust the image viewed on the screen 408 or 444. The housing 402 is typically adapted for mounting on a camera 102.

The viewfinder 104 may comprise a light source 506, and one or more imaging panels 502 or 508 that receive light from the light source and produces an optical output representative of an image. The image may be derived from a video signal received from the camera 102. The light source 506 and one or more imaging panels 502 or 508 are typically deployed within the housing 402.

The light source 506 may produce white light whereby a plurality of color filters provide a different colored light to each of the one or more imaging panels 502 or 508. The light source 506 may produce a sequential series of light wavelengths for provision to a single panel 502 or 506. In one example, the light source 506 comprises a plurality of differently colored LEDs. In some embodiments, the imaging panels comprise a DMD 502. In some embodiments, the imaging panels comprise an LCD panel 508.

A screen 408 or 444 may be deployed to display the image produced by the one or more imaging panels 502. The light source 506 and screen 408 or 444 are typically deployed within the housing 402. The screen 408 or 444 can be rectangular and typically has a diagonal dimension of nine inches or less. In some embodiments screen 408 or 444 has a diagonal dimension of two inches or less. Characteristics of the screen 408 or 444 deployed within the viewfinder 104 are selected to provide a desired resolution. For example, the screen 408 or 444 may be used to display standard definition images having an aspect ratio of 4:3, or high definition images having another aspect ratio, such as 16:19, with 800×480 pixels or 960×540 pixels.

The screen 408 or 444 has front and rear sides and, in some embodiments, screen 408 receives light from the imaging panels 502 or 508 at the rear of screen 408 or 444, while the image is viewable through the eyepiece 450 or objective lens 410 on the front side of screen 408 or 444. In such embodiments, screen 408 or 444 may be constructed from a granular material, whereby the resolution of screen 408 or 444 is determined by the size of particles and/or granularity of the material. The screen 408 or 444 may be constructed from a fibrous material, and the resolution of the screen 408 or 444 may be determined by fiber width and/or tightness of weave. In some embodiments, screen 408 or 444 comprises a PTFE foil.

In some embodiments, the image is viewed as a reflection from screen 408 or 444 and resolution of the screen 408 or 444 may then be determined by a texture of a surface of the screen 408 or 444. The texture of the surface of the screen 408 or 444 may derived from one or more of a chemical treatment of the surface, an embossing of the surface, and an etching of the surface.

In some embodiments, one or more optical elements 422, 412, 414 and 416 may be arranged and configured to provide a desired optical path length between the imaging panel 502 or 508 and the screen 408 or 444. Optical elements may comprise one or more refractive and/or reflective elements such as a lens, a mirror, a prism a collimator, etc. The optical elements may be complex elements including multiple individual components.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A viewfinder, comprising:
a light source;
one or more imaging panels that receive light from the light source and produces an optical output representative of an image;
a screen that displays the image; and
a housing that encloses the light source, the one or more imaging panels and the screen, wherein the housing is adapted to receive a magnifying eyepiece used to view the image displayed on the screen.

2. The viewfinder of claim 1, wherein the housing is adapted for mounting on a camera, and wherein the optical output is produced from a video signal provided by the camera.

3. The viewfinder of claim 2, wherein the screen is rectangular and has a diagonal dimension of nine inches or less.

4. The viewfinder of claim 3, wherein the screen has a diagonal dimension of two inches or less.

5. The viewfinder of claim 3, wherein the screen has a resolution sufficient to display standard definition images and high definition images.

6. The viewfinder of claim 3, wherein the screen supports an image resolution that is selectable between 800×480 pixels and 1280×800 pixels.

7. The viewfinder of claim 3, wherein the screen has a front side and a rear side, and wherein the screen receives the optical output on the rear side of the screen and the image is viewable through the magnifying eyepiece on the front side of the screen.

8. The viewfinder of claim 7, wherein the screen is constructed from a granular material, and wherein the screen has a resolution that is determined by a granularity of the granular material.

9. The viewfinder of claim 7, wherein the screen is constructed from a fibrous material, and wherein the screen has a resolution that is determined by a fiber width.

10. The viewfinder of claim 7, wherein the screen comprises a polytetrafluoroethylene foil.

11. The viewfinder of claim 5, wherein the image is viewable as a reflection from the screen.

12. The viewfinder of claim 11, wherein the screen has a resolution that is determined by a texture of a surface of the screen.

13. The viewfinder of claim 12, wherein the texture of the surface of the screen is derived from one or more of a chemical treatment of the surface, an embossing of the surface, and an etching of the surface.

14. The viewfinder of claim 1, wherein the light source produces white light, and further comprising a plurality of color filters that provides a different colored light to each of the one or more imaging panels.

15. The viewfinder of claim 1, wherein the light source sequentially produces light having different wavelengths, wherein the one or more imaging panels comprises a single panel that is sequentially illuminated with the different wavelengths.

16. The viewfinder of claim 1, wherein the one or more imaging panels comprise a digital micromirror device.

17. The viewfinder of claim 1, wherein the one or more imaging panels comprise a liquid crystal display panel.

18. The viewfinder of claim 1, further comprising one or more optical elements configured to provide a desired optical path length between the one or more imaging panels and the screen.

19. The viewfinder of claim 18, wherein the one or more optical elements includes a reflective element.

20. The viewfinder of claim 18, wherein the one or more optical elements includes a refractive element.

21. A method, comprising:
providing a video signal to one or more imaging panels;
illuminating the one or more imaging panels with a light; and
projecting an image derived from the video signal on a surface of a screen,
wherein the one or more imaging panels and the screen are collocated within a viewfinder of a camera, and wherein the image projected on the surface of the screen is viewable through an eyepiece of the viewfinder.

22. The method of claim 21, wherein the video signal is received from the camera.

23. The method of claim 22, wherein the screen is rectangular and has a diagonal dimension of nine inches or less.

24. The method of claim 23, wherein the screen has a diagonal dimension of two inches or less.

25. The method of claim 23, wherein the screen has a resolution sufficient to display standard definition images and high definition images.

26. The method of claim 25, wherein the screen has a resolution that is selectable between 800×480 pixels and 1280×800 pixels.

27. The method of claim 25, wherein the image is projected on a surface on a first side of the screen, and wherein the image is viewable through the eyepiece on a second side of the screen.

28. The method of claim 27, wherein the screen is constructed from a granular material, and wherein the screen has a resolution that is determined by a granularity of the granular material.

29. The method of claim 27, wherein the screen is constructed from a fibrous material, and wherein the screen has a resolution that is determined by a fiber width.

30. The method of claim 27, wherein the screen comprises a polytetrafluoroethylene foil.

31. The method of claim 25, wherein the image is viewable as a reflection from the surface of the screen.

32. The method of claim 31, wherein a resolution of the screen is determined by a texture of the surface of the screen.

33. The method of claim 32, wherein the texture of the surface of the screen is created by one or more of a chemical treatment of the surface, an embossing of the surface, and an etching of the surface.

34. The method of claim 21, wherein illuminating the one or more imaging panels with a light includes:
filtering a white light with filters to obtain a plurality of different colored wavelengths; and
illuminating each of the one or more imaging panels with one of the plurality of different colored wavelengths.

35. The method of claim 21, wherein the one or more imaging panels comprise a single panel, and further comprising sequentially illuminating the one or more imaging panels with light of different wavelengths.

36. The method of claim 21, wherein the one or more imaging panels comprise a digital micromirror device.

37. The method of claim 21, wherein the one or more imaging panels comprise a liquid crystal display panel.

38. The method of claim 21, further comprising providing an optical path between the one or more imaging panels and the screen using one or more optical elements configured to provide a desired length of the optical path.

39. The method of claim 38, wherein the one or more optical elements includes a reflective element.

40. The method of claim 38, wherein the one or more optical elements includes a refractive element.

41. A viewfinder apparatus, comprising:
means for providing a video signal to one or more imaging panels;
means for illuminating the one or more imaging panels with a light; and
means for projecting an image derived from the video signal on a surface of a screen,
wherein the one or more imaging panels and the screen are collocated within a viewfinder of a camera, and wherein the image projected on the surface of the screen is viewable through an eyepiece of the viewfinder.

42. The viewfinder apparatus of claim 41, wherein the video signal is received from the camera.

43. The viewfinder apparatus of claim 42, wherein the screen is rectangular and has a diagonal dimension of nine inches or less.

44. The viewfinder apparatus of claim 43, wherein the screen has a diagonal dimension of two inches or less.

45. The viewfinder apparatus of claim 43, wherein the screen has a resolution sufficient to display standard definition images and high definition images.

46. The viewfinder apparatus of claim 45, wherein the screen has a resolution that is selectable between 800×480 pixels and 960×540 pixels.

47. The viewfinder apparatus of claim 45, wherein the image is projected on a surface on a first side of the screen, and wherein the image is viewable through the eyepiece on a second side of the screen.

48. The viewfinder apparatus of claim 47, wherein the screen is constructed from a granular material, and wherein a resolution of the screen is determined by a granularity of the granular material.

49. The viewfinder apparatus of claim 47, wherein the screen is constructed from a fibrous material, and wherein a resolution of the screen is determined by a fiber width.

50. The viewfinder apparatus of claim 47, wherein the screen comprises a polytetrafluoroethylene foil.

51. The viewfinder apparatus of claim 45, wherein the image is viewable as a reflection from the surface of the screen.

52. The viewfinder apparatus of claim 41, wherein a resolution of the screen is determined by a texture of the surface of the screen.

53. The viewfinder apparatus of claim 52, wherein the texture of the surface of the screen is created by one or more of a chemical treatment of the surface, an embossing of the surface, and an etching of the surface.

54. The viewfinder apparatus of claim 41, wherein the means for illuminating the one or more imaging panels filters a white light with filters to obtain a plurality of different colored wavelengths, and illuminates each of the one or more imaging panels with one of the plurality of different colored wavelengths.

55. The viewfinder apparatus of claim 41, wherein the one or more imaging panels comprise a single panel, and wherein the one or more imaging panels are sequentially illuminated with light of different wavelengths.

56. The viewfinder apparatus of claim 41, wherein the one or more imaging panels comprise a digital micromirror device.

57. The viewfinder apparatus of claim 41, wherein the one or more imaging panels comprise a liquid crystal display panel.

58. The viewfinder apparatus of claim 41, further comprising optical means for providing an optical path having a desired obtain a desired length between the one or more imaging panels and the screen.

59. The viewfinder apparatus of claim 58, wherein the optical means comprises a reflective element.

60. The viewfinder apparatus of claim 58, wherein the optical means comprises a refractive element.
